(19) United States
(12) Patent Application Publication
(10) Pub. No.: US 2016/0259670 A1
(43) Pub. Date: Sep. 8, 2016

(54) COMPUTER READABLE MEDIUM, MAPPING INFORMATION GENERATING METHOD, AND MAPPING INFORMATION GENERATING APPARATUS

(71) Applicant: FUJITSU LIMITED, Kawasaki-shi (JP)

(72) Inventor: Yusuke Oishi, Yokohama (JP)

(73) Assignee: FUJITSU LIMITED, Kawasaki-shi (JP)

(21) Appl. No.: 14/989,563

(22) Filed: Jan. 6, 2016

(30) Foreign Application Priority Data
Mar. 5, 2015 (JP) 2015-043370

(51) Int. Cl. G06F 9/50

(52) U.S. Cl. CPC G06F 9/5027

(57) ABSTRACT

Provided is a non-transitory computer readable medium storing a mapping information generation program that causes a computer to execute a process, the process including: placing a plurality of processes in a space generated by a computer; changing positions of the plurality of processes by applying at least one of an attracting force and a repulsive force between each two processes included in the plurality of processes; and generating information that maps the plurality of processes to a plurality of processors based on changed positions of the plurality of processes and positions of the plurality of processors.

### CROSS-REFERENCE TO RELATED APPLICATION

This application is based upon and claims the benefit of priority of the prior Japanese Patent Application No. 2015-043370, filed on Mar. 5, 2015, the entire contents of which are incorporated herein by reference.

### FIELD

A certain aspect of embodiments described herein relates to a computer readable medium, a mapping information generating method, and a mapping information generating apparatus.

### BACKGROUND

There has been known a parallel computing system using multiple computers (hereinafter, referred to as nodes) to execute arithmetic processing in parallel as disclosed in, for example, Japanese Patent Application Publication No. 2014-137732 (Patent Document 1). The use of the parallel computing system greatly reduces computation time required for a large-scale numerical analysis.

In recent years, to fulfill the requirement for computational performance, there has been used not only an indirect network parallel computing system that indirectly interconnects nodes through a switch, but also a direct network parallel computing system that directly interconnects nodes. A fat tree network has been known as the example of the indirect network, while a torus network and a mesh network have been known as the example of the direct network. The torus network includes a variety of forms. A three dimensional torus that has a cuboid grid structure has been known as one of them (see Patent Document 1).

In the aforementioned direct network parallel computing system, a technique called rank location optimization has been known as disclosed in, for example, Hiroaki IMADE and six others, “Reduction of Execution Time of RMATT for Communication Time Optimization for Large Scale Computation”, High Performance Computing Symposium 2012, Information Processing Society of Japan, January, 2012, p. 93-100 (Non Patent Document 1). This is a technology that assigns (maps) ranks to proper nodes in response to a communication pattern when a Message Passing Interface (MPI) application is executed in the direct network parallel computing system. Here, the MPI application is a parallel program written in MPI. The rank is a number that is given to each process of the MPI application when the MPI application is executed. However, a process given a rank is sometimes called as a rank. When the MPI application is executed based on the locations of the ranks obtained by the rank location optimization, the number of nodes passed through (the number of hops) and the congestion at the time of inter-process communication are reduced, and the communication processing time required for the inter-process communication can be reduced.

Various techniques have been suggested for the aforementioned rank location optimization. For example, there has been suggested a technique that divides a process group including multiple processes into divided process groups based on a result of the division of a network area including multiple nodes, and then places the divided process groups in one of the divided network areas as disclosed in, for example, Japanese Patent Application Publication No. 2012-243224 (Patent Document 2). Moreover, there has been suggested Simulated Annealing (SA) that measures communication load and randomly searches the optimized solution of the locations of the ranks based on the measurement results (see Non Patent Document 1).

### SUMMARY

According to an aspect of the present invention, there is provided a non-transitory computer readable medium storing a mapping information generation program that causes a computer to execute a process, the process including: placing a plurality of processes in a space generated by a computer; changing positions of the plurality of processes by applying at least one of an attracting force and a repulsive force between each two processes included in the plurality of processes; and generating information that maps the plurality of processes to a plurality of processors based on changed positions of the plurality of processes and positions of the plurality of processors.

### BRIEF DESCRIPTION OF DRAWINGS

FIG. 1 is a diagram for explaining an exemplary parallel computing system;

FIG. 2 is a block diagram illustrating a hardware configuration of a node;

FIG. 3 illustrates a hardware configuration of a mapping information generating apparatus;

FIG. 4 is a block diagram of the mapping information generating apparatus;

FIG. 5 illustrates an example of a communication pattern;

FIG. 6 is a diagram for explaining a division of ranks;

FIG. 7 illustrates an example of an initial state;

FIG. 8 is a flowchart illustrating a process of a mapping information generating method;

FIG. 9A is a graph illustrating a relationship between a distance between ranks and a force acting between the ranks, and FIG. 9B is a diagram for explaining a force acting on a rank j;

FIG. 10 illustrates an example of changed locations of the ranks;

FIG. 11 is a flowchart of an alignment process;

FIGS. 12A and 12B are diagrams for explaining an example of the alignment process;

FIGS. 13A and 13B are diagrams illustrating another example of the alignment process;

FIG. 14 is a diagram for explaining trajectories of ranks of which the locations are changed in an XY plane as a time step increases;

FIG. 15 illustrates mapping information; and

FIG. 16 is a graph illustrating a relationship between the increase of the time step and an evaluation value.

### DESCRIPTION OF EMBODIMENTS

When the Simulated Annealing disclosed in Non Patent Document 1 is employed in a large scale parallel computing system, the processing quantity of search explosively increases because the search is randomly performed, and the calculation amount required to obtain the optimized solutions of the locations of the ranks thereby increases. That is to say, there is a problem that the large amount of time is required to obtain the optimized solution of the locations of the ranks.

Hereinafter, a description will be given of an embodiment with reference to accompanying drawings.

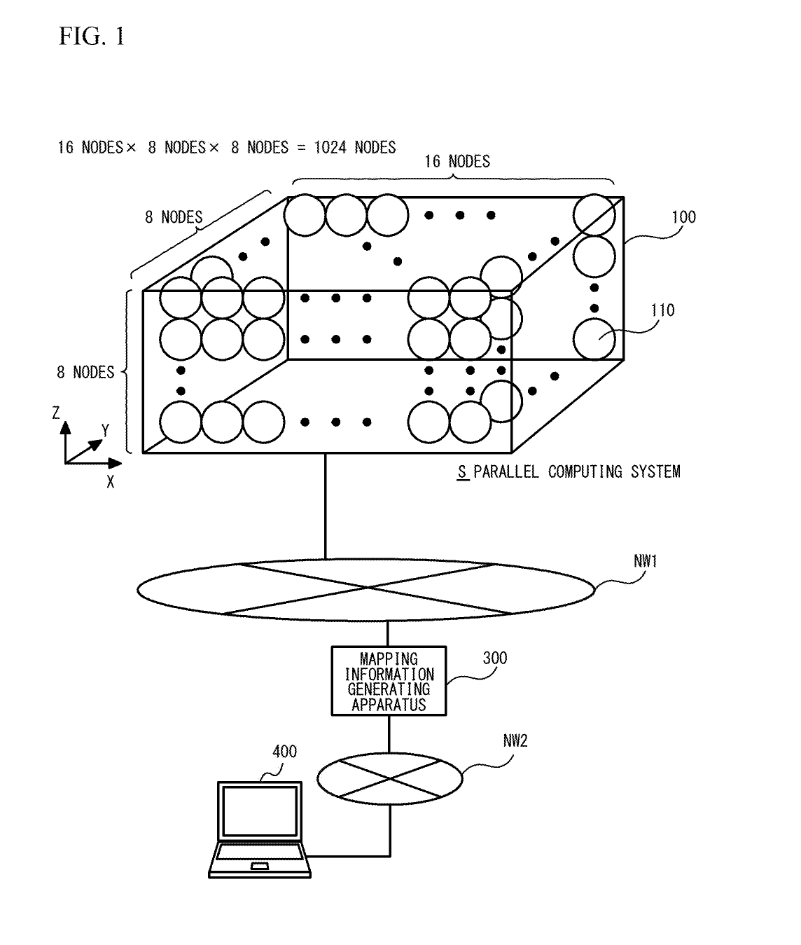

FIG. 1 is a diagram for explaining an exemplary parallel computing system S. The parallel computing system S includes a computing node group 100 and a mapping information generating apparatus 300. The computing node group 100 includes multiple nodes 110 that form a cuboid grid structure. The computing node group 100 obtains the positions of the multiple nodes 110 from a user, and places the nodes 110 in the space constructed on a computer. In FIG. 1, by the specification from the user, 16 nodes 110 are placed in an X axis direction, 8 nodes 110 are placed in a Y axis direction, and 8 nodes 110 are placed in a Z axis direction. That is to say, FIG. 1 illustrates the computing node group 100 having a 16×8×8 network topology. Thus, the computing node group 100 includes 1024 nodes 110 in total. The number of the nodes 110 included in the computing node group 100 is not limited to the aforementioned number of the nodes. For example, four nodes 110 may be placed in each of the X axis direction, the Y axis direction, and the Z axis direction to form a cubic grid structure.

The topology of the multiple nodes 110 included in the computing node group 100 is a three-dimensional torus. Thus, a line of the multiple nodes 110 placed on the X axis is connected in a ring shape, and a line of the multiple nodes 110 placed on the Y axis is also connected in a ring shape. In the same manner, a line of the multiple nodes 110 placed on the Z axis is connected in a ring shape.

The mapping information generating apparatus 300 is coupled to the computing node group 100 through a network NW1. The examples of the network NW1 include, for example, a Local Area Network (LAN). The mapping information generating apparatus 300 generates mapping information that defines which node 110 a process given a rank (hereinafter, referred to as a rank as appropriate) is to be mapped to. The mapping information may be called, for example, a rank map file, or a rank location file. The mapping information generating apparatus 300 maps the ranks to the multiple nodes 110 on a one-to-one basis based on the generated mapping information. This reduces the number of nodes passed through (the number of hops) and the congestion at the time of inter-process communication, thereby reducing the communication processing time required for the inter-process communication. At least one of the multiple nodes 110 included in the computing node group 100 may execute the function of the mapping information generating apparatus 300.

A terminal device 400 is coupled to the mapping information generating apparatus 300 through a network NW2. The examples of the network NW2 include, for example, the Internet. The terminal device 400 may be, for example, a Personal Computer (PC), a tablet terminal, or a handheld terminal. The user operates the terminal device 400 to transmit, in addition to the aforementioned network topology, at least a communication pattern described later to the mapping information generating apparatus 300. An initial state described later is also transmitted when the transmission of the initial state is requested. The mapping information generating apparatus 300 generates the mapping information based on at least the network topology and the communication pattern.

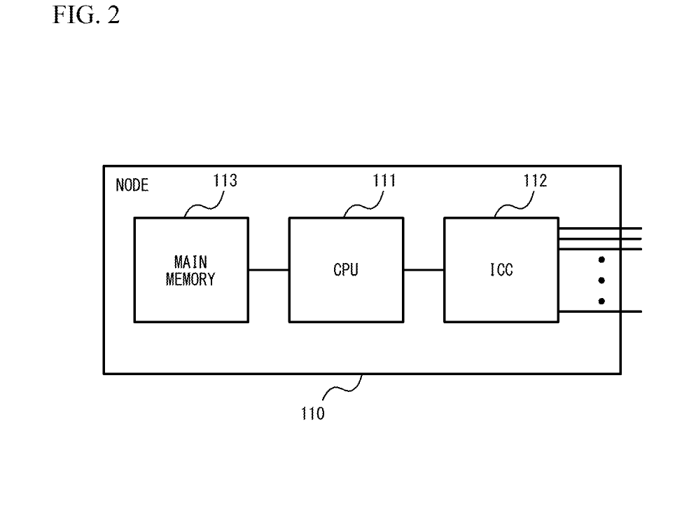

A description will next be given of a hardware configuration of the aforementioned node 110 with reference to FIG. 2.

FIG. 2 is a block diagram illustrating a hardware configuration of the node 110. The node 110 includes a Central Processing Unit (CPU) 111, an Inter Connect Controller (ICC) 112, and a main memory 113. As the main memory, employed is, for example, a Dual Inline Memory Module (DIMM). The CPU 111 may be a single core processor including a single core, or may be a multi-core processor including multiple (e.g., eight) cores. In the case of the single core processor, the CPU 111 executes a single process at a time, while in the case of the multi-core processor, the CPU 111 can execute processes in a number corresponding to the number of cores at a time.

The ICC 112 and the main memory 113 are coupled to the CPU 111. The ICC 112 has multiple ports, and is coupled to the ICC 112 of each of the adjacent nodes 110 through the corresponding port. For example, when the ICC 112 has six ports, the ICC 112 is coupled to the ICC 112 of the adjacent node 110 through a first port in the +X axis direction, and is coupled to the ICC 112 of the adjacent node 110 through a second port in the −X axis direction. In the same manner, the ICC 112 is coupled to the ICC 112 of the adjacent node 110 through a third port in the +Y axis direction, and is coupled to the ICC 112 of the adjacent node 110 through a fourth port in the −Y axis direction. The ICC 112 is coupled to the ICC 112 of the adjacent node 110 through a fifth port in the +Z axis direction, and is coupled to the ICC 112 of the adjacent node 110 through a sixth port in the −Z axis direction. Each node 110 to which a rank is assigned executes the process while communicating with other nodes 110.

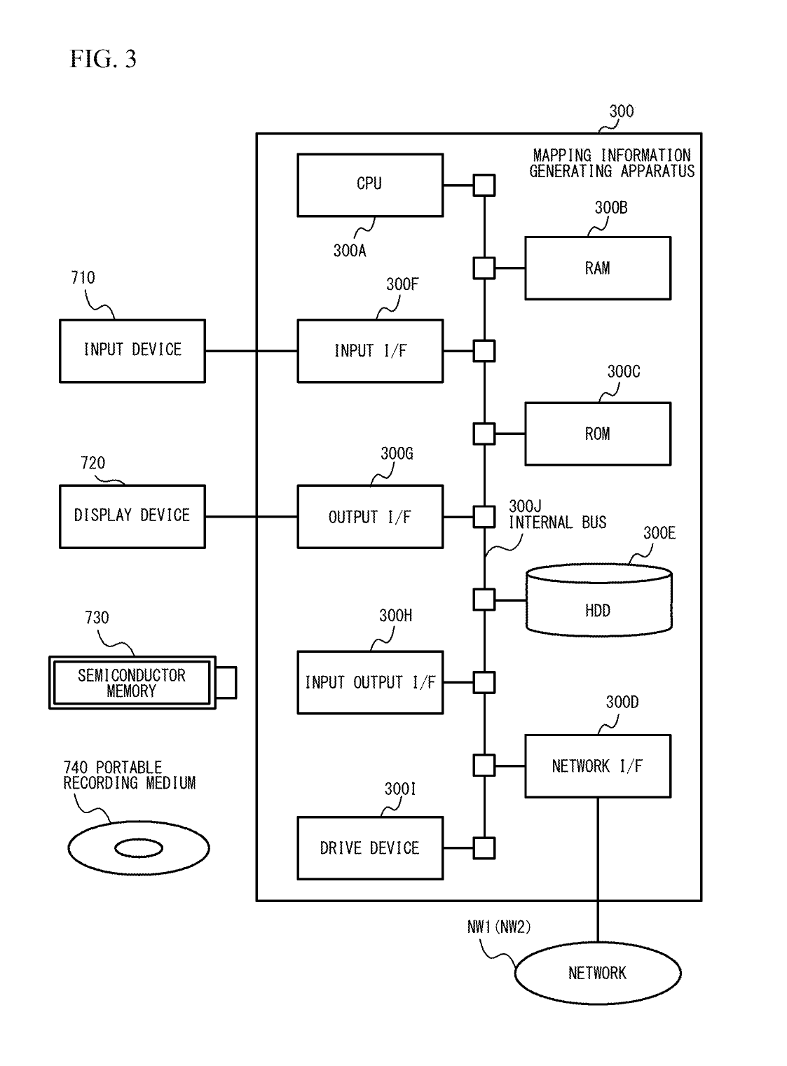

A description will next be given of a hardware configuration of the aforementioned mapping information generating apparatus 300 with reference to FIG. 3.

FIG. 3 illustrates a hardware configuration of the mapping information generating apparatus 300. As illustrated in FIG. 3, the mapping information generating apparatus 300 includes at least a CPU 300A, a Random Access Memory (RAM) 300B, a Read Only Memory (ROM) 300C, and a network interface (I/F) 300D. The mapping information generating apparatus 300 may include at least one of a Hard Disk Drive (HDD) 300E, an input I/F 300F, an output I/F 300G, an input output I/F 300H, and a drive device 300I as necessary. The CPU 300A through the drive device 300I are interconnected through an internal bus 300J. The cooperation of at least the CPU 300A and the RAM 300B realizes a computer.

An input device 710 is coupled to the input I/F 300F. The examples of the input device 710 include, for example, a keyboard, and a mouse.

A display device 720 is coupled to the output I/F 300G. The examples of the display device 720 include, for example, a liquid crystal display.

A semiconductor memory 730 is coupled to the input output I/F 300H. The examples of the semiconductor memory 730 include, for example, a Universal Serial Bus (USB) memory, and a flash memory. The input output I/F 300H reads programs and data stored in the semiconductor memory 730.

The input I/F 300F and the input output I/F 300H include, for example, a USB port. The output I/F 300G includes, for example, a display port.

A portable recording medium 740 is inserted into the drive device 300I. The examples of the portable recording medium 740 include, for example, a removable disk such as a Compact Disc (CD)-ROM and a Digital Versatile Disc (DVD). The drive device 300I reads programs and data stored in the portable recording medium 740.

The network I/F 300D includes, for example, a port and a Physical Layer Chip (PHY chip). The mapping information generating apparatus 300 is coupled to the networks NW1, NW2 through the network I/F 300D.

The CPU 300A causes the aforementioned RAM 300B to store the programs stored in the ROM 300C and the HDD 300E. The CPU 300A causes the RAM 300B to store the programs stored in the portable recording medium 740. The execution of the stored programs by the CPU 300A implements the various functions described later, and implements the various operations. The programs are configured to correspond to flowcharts described later.

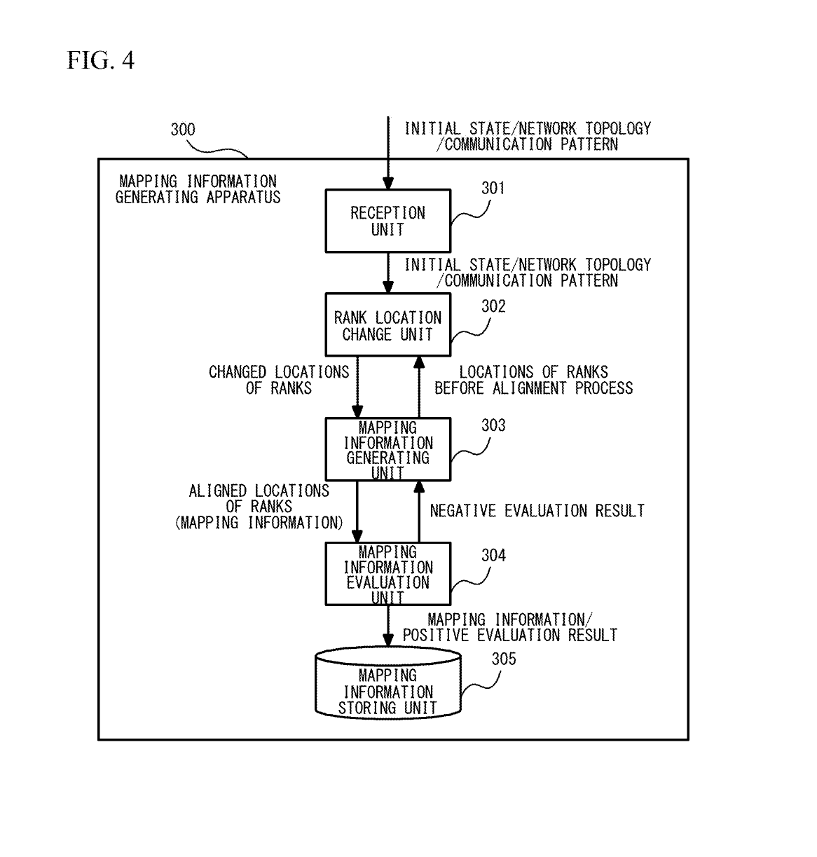

A description will next be given of the specifics of the mapping information generating apparatus 300 with reference to FIG. 4 through FIG. 7.

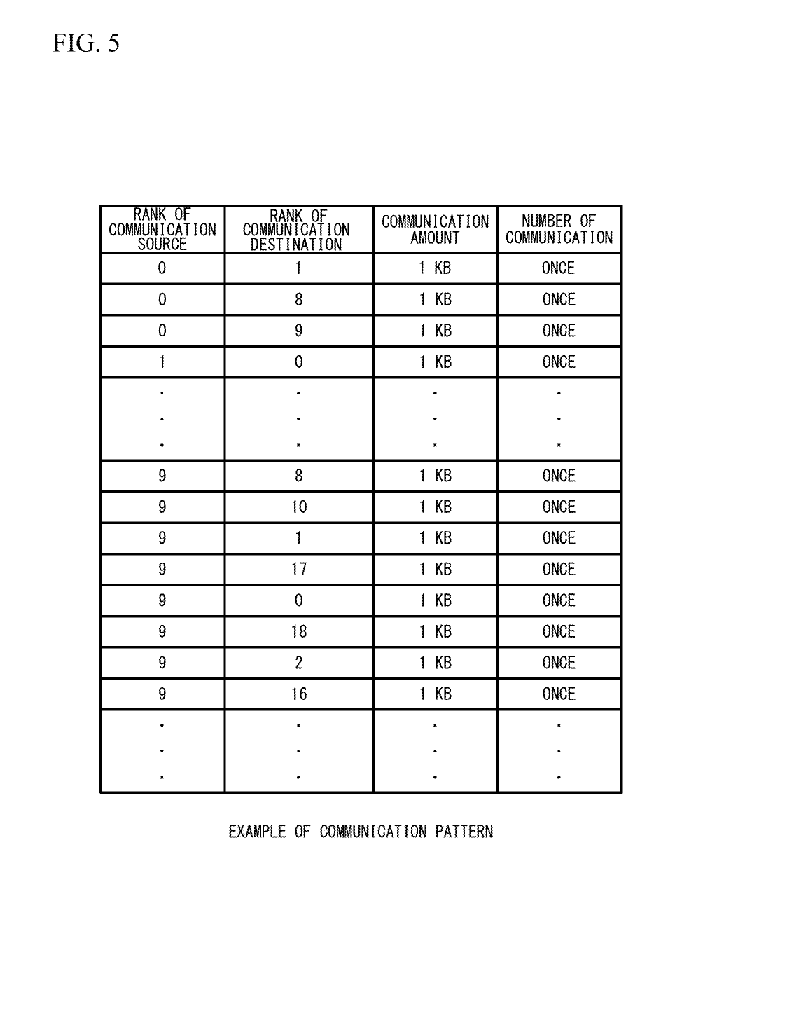

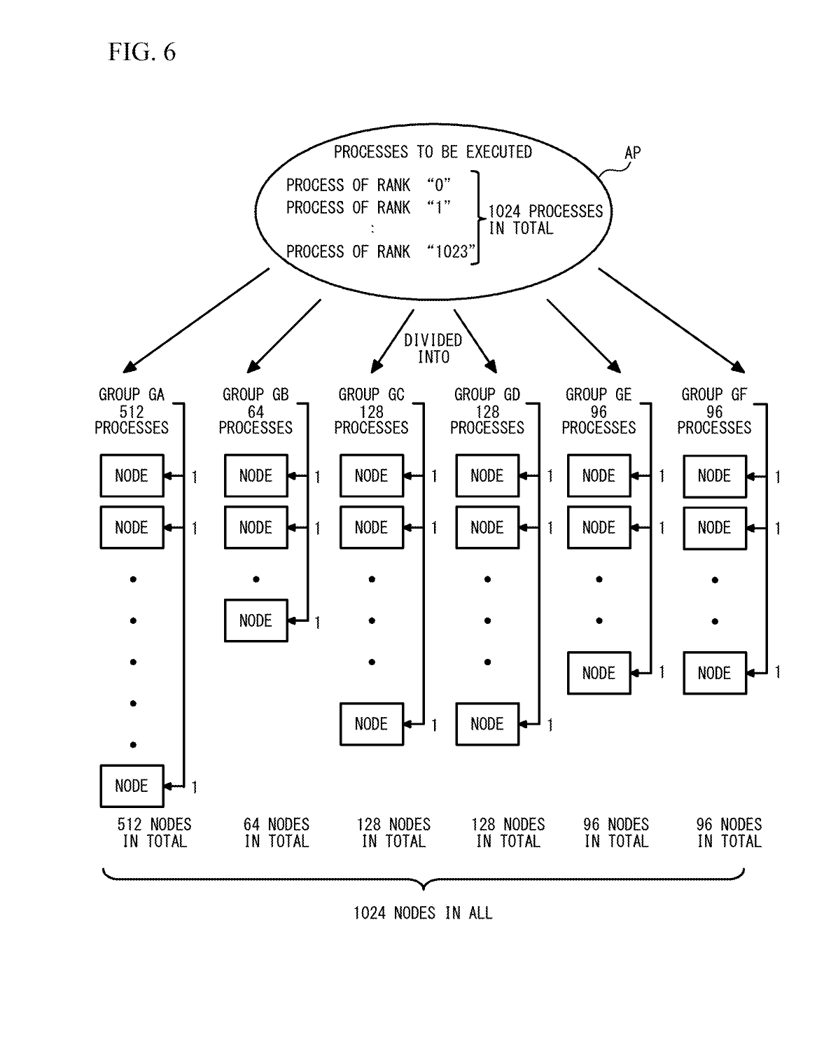

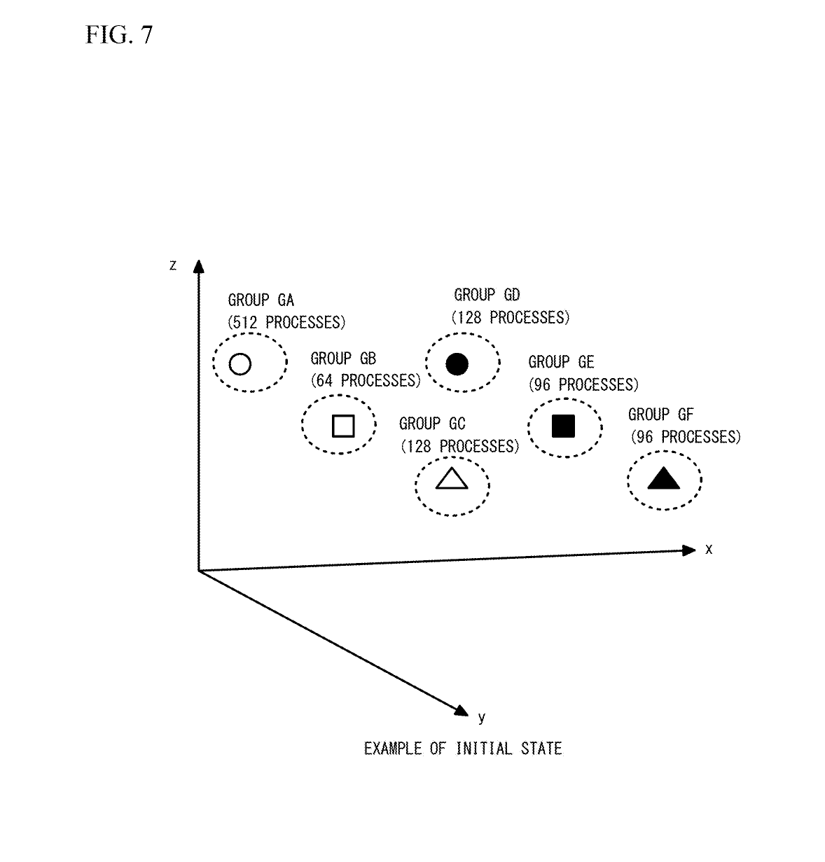

FIG. 4 is a block diagram of the mapping information generating apparatus 300. FIG. 5 illustrates an example of the communication pattern. FIG. 6 is a diagram for explaining the division of ranks. FIG. 7 illustrates an example of the initial state.

The mapping information generating apparatus 300 includes, as illustrated in FIG. 4, a reception unit 301, a rank location change unit 302 as a change unit, a mapping information generating unit 303 as a generation unit, a mapping information evaluation unit 304, and a mapping information storing unit 305.

The reception unit 301 receives the initial state, the network topology, and the communication pattern from the terminal device 400. The reception unit 301 transmits the initial state, the network topology, and the communication pattern that have been received to the rank location change unit 302. The communication pattern includes, as illustrated in FIG. 5, a rank of communication source, a rank of communication destination, a communication amount, and the number of communication as components. According to the communication pattern illustrated in FIG. 5, for example, the process given the rank (the rank of communication source) “0” communicates with each of the processes given the ranks (the rank of communication destination) “1”, “8”, and “9” in three directions as communication partners “once” (the number of communication) with a communication amount of “1 KB”. For example, the process given the rank (the rank of communication source) “9” communicates with each of the processes given the ranks (the rank of communication destination) “0”, “1”, “2”, “8”, “10”, “16”, “17”, and “18” in eight directions as communication partners “once” (the number of communication) with a communication amount of “1 KB”. The communication pattern is obtained by the computing node group 100 executing the MPI application before the generation of the mapping information.

For example, when the computing node group 100 executes the MPI application AP illustrated in FIG. 6, ranks “0” through “1023” are given to the processes on a one-to-one basis. Then, the computing node group 100 analyzes which process given a rank communicates with which process, what amount the communication amount is, and how many times the communication is performed to obtain the communication pattern including the rank of communication source, the rank of communication destination, and the like. The communication pattern may be based on the communication amount and the number of communication per unit time, or may be based on the communication amount and the number of communication from the start to the end of the execution of the MPI application AP.

The computing node group 100 generates the aforementioned initial state based on the communication pattern obtained as described above. More specifically, the computing node group 100 divides the processes into multiple groups each including ranks that frequently communicate with each other based on the communication amount between the ranks included in the communication pattern and the network topology. For example, as illustrated in FIG. 6, the computing node group 100 divides all the processes of the rank “0” to the rank “1023” into individual six groups GA through GF based on the communication frequency between ranks. That is to say, 512 processes included in the group GA communicate with each other at higher frequency than 512 processes included in the groups GB through GF. The same applies to the groups GB through GF. The convergence of the locations of the ranks is accelerated by placing the ranks that frequently communicate with each other in an area corresponding to the group in the space constructed on the computer based on the communication pattern between the ranks, and thereby the optimized locations of the ranks can be obtained in short time. As a result, as illustrated in FIG. 7, the computing node group 100 generates the initial state in which the processes to be executed are divided into the group GA including 512 processes, the group GB including 64 processes, . . . , the group GF including 96 processes. In FIG. 7, each of the groups GA through GF seems to include only one process, but since two or more processes overlap each other, only one process is illustrated.

As illustrated in FIG. 6, the processes included in each of the groups GA through GF are assigned to the nodes 110 (in more detail, the CPUs 111). For example, when the CPU 111 included in the node 110 is a single core processor, the 512 processes included in the group GA are assigned to 512 nodes on a one-to-one basis. The same applies to the groups GB through GF. The communication pattern and the initial state may be prepared in advance instead of being generated in advance through the above described procedure.

The rank location change unit 302 receives information on the initial state, the network topology, and the communication pattern transmitted from the reception unit 301. When the rank location change unit 302 does not receive the information on the initial state, it determines that the computing node group 100 did not generate the initial state, and generates the initial state based on the information on the communication pattern. The rank location change unit 302 conforms the aspect ratio of the system in molecular dynamics (MD) to the aspect ratio of the received network topology after the reception. Therefore, when the network topology is 16×8×8, the aspect ratio of the system becomes 16×8×8. The present embodiment uses the concept of molecular dynamics as described above. This aims to little change the positions of the ranks from the simulation result as much as possible in the process of aligning the locations of the ranks described later. The rank in the present embodiment corresponds to the atom in molecular dynamics.

The rank location change unit 302 calculates an attracting force corresponding to communication traffic between the ranks and the distance between the ranks, or a repulsive force corresponding to the distance between the ranks based on the distance between the ranks obtained from the initial state, and the communication amount and the number of communication included in the communication pattern. The communication traffic may be called communication load. Although the details will be described later, depending on the distance between the ranks, an attracting force or a repulsive force is generated between the ranks. The rank location change unit 302 calculates the attracting force or the repulsive force, and then changes the locations of the ranks representing the position of each rank by applying at least one of the attracting force and the repulsive force between the ranks. The rank location change unit 302 transmits the changed locations of the ranks to the mapping information generating unit 303. The specifics of the rank location change unit 302 will be described later.

The mapping information generating unit 303 generates the mapping information by assigning the ranks of which the locations have been changed to the nodes 110 depending on the network topology while keeping the changed locations of the ranks transmitted from the rank location change unit 302. The changed locations of the ranks that have been transmitted do not correspond to the nodes 110. Thus, the mapping information generating unit 303 moves the changed locations of the ranks to the positions of the nodes 110 to associate the ranks to the nodes 110 on a one-to-one basis. Hereinafter, although the details will be described later, the process that moves the changed location of the rank to the position of the node 110 is called an alignment process. The mapping information generating unit 303 transmits the aligned locations of the ranks by the alignment process, i.e., the generated mapping information, to the mapping information evaluation unit 304.

The mapping information evaluation unit 304 receives the mapping information transmitted from the mapping information generating unit 303. The mapping information evaluation unit 304 evaluates the received mapping information by using predetermined evaluation formulas described later. The mapping information evaluation unit 304 determines that the positive evaluation result is obtained when the improved evaluation value compared to the evaluation value obtained last time is obtained, and outputs the mapping information to the mapping information storing unit 305. At this time, the mapping information evaluation unit 304 may output the improved evaluation value as the positive evaluation result together with the mapping information. On the other hand, the mapping information evaluation unit 304 determines that the negative evaluation result is obtained when the improved evaluation value compared to the evaluation value obtained last time is not obtained, and outputs the acquisition of the negative evaluation result to the mapping information generating unit 303. Thus, the mapping information generating unit 303 transmits the changed locations of the ranks that have been kept, i.e., the locations of the ranks before the alignment process, to the rank location change unit 302. The rank location change unit 302 changes the locations of the ranks again when receiving the locations of the ranks before the alignment process. The repetition of the above-described process by the rank location change unit 302 enables to finally obtain the more improved mapping information.

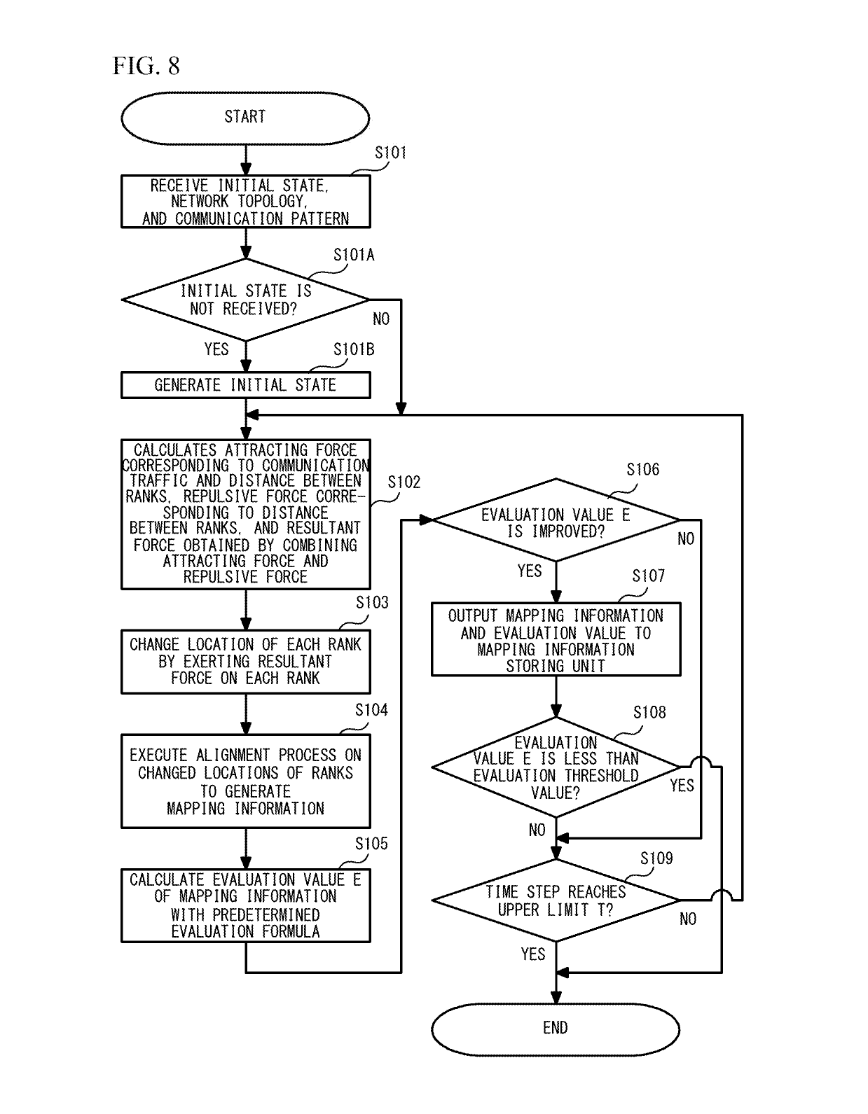

A description will next be given of the operation of the mapping information generating apparatus 300 with reference to FIG. 8 through FIG. 10.

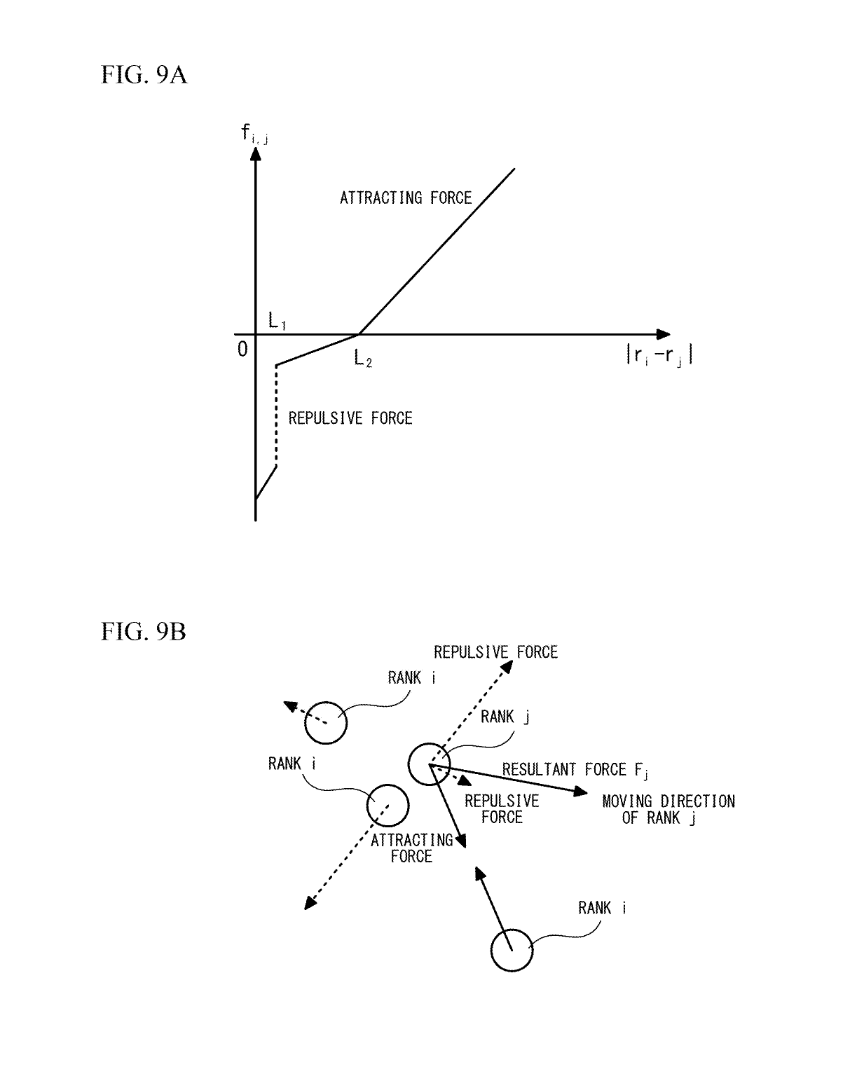

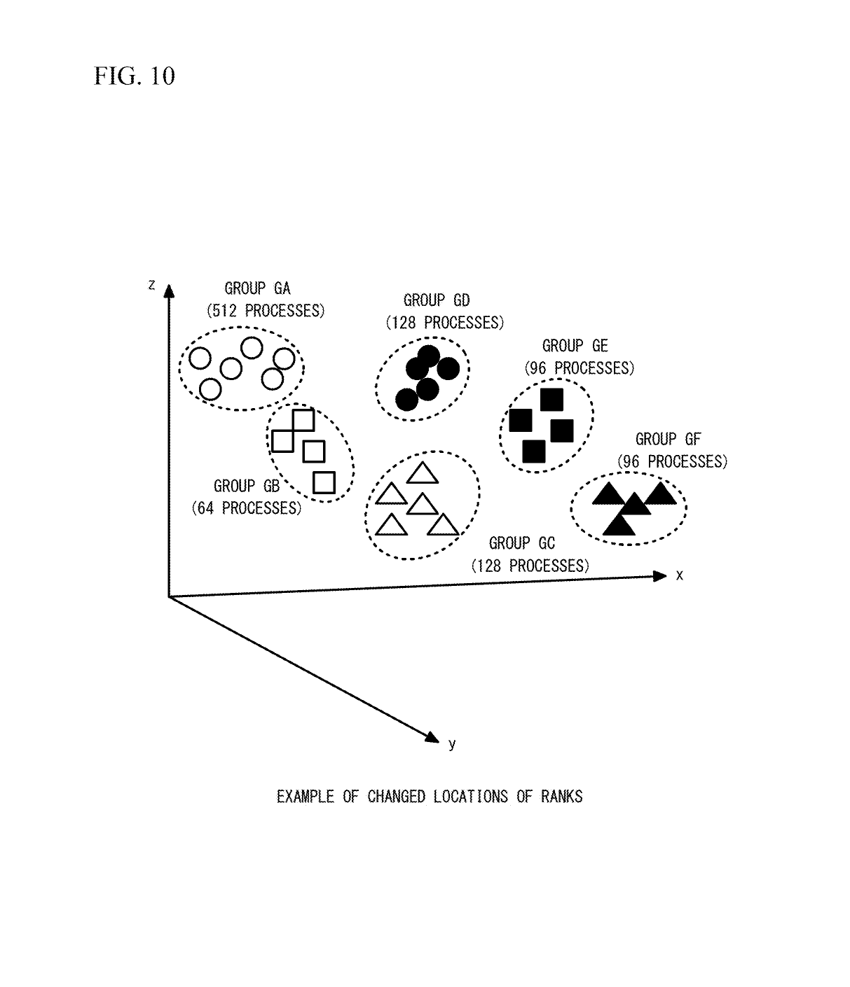

FIG. 8 is a flowchart of an exemplary mapping information generating method. FIG. 9A is a graph illustrating a relationship between the distance between ranks and the force acting between the ranks. FIG. 9B is a diagram for explaining an example of the force acting on a rank j. FIG. 10 illustrates the example of the changed locations of the ranks.

The reception unit 301 receives the initial state, the network topology, and the communication pattern transmitted from the terminal device 400 (step S101). When the rank location change unit 302 determines that it does not receive the initial state (step S101A: YES), it generates the initial state (step S101B). Thus, the rank location change unit 302 places multiple ranks in a space constructed on a computer.

When the rank location change unit 302 ends the process of step S101B, or determines that it receives the initial state (step S101A: NO), it calculates an attracting force with a magnitude corresponding to the communication traffic between the ranks and the distance between the ranks, a repulsive force with a magnitude corresponding to the distance between the ranks, and a resultant force obtained by combining the attracting force and the repulsive force (step S102). More specifically, the rank location change unit 302 calculates communication traffic C_{i,j} of the communication between a rank i and a rank j based on the communication amount and the number of communication between the rank i and the rank j included in the communication pattern, and the following formula (1). The value “20000” included in the formula (1) is a constant, and the constant may be changed as appropriate. The following formula (1) defines a larger one of the value “1” and the result of the multiplication of the value “20000”, the communication amount, and the number of communication as the communication traffic C_{i,j}. If the result of the multiplication is simply defined as the communication traffic C_{i,j} and the communication does not occur, the number of communication becomes zero, and the value of the result of the multiplication also becomes zero. Accordingly, the value of the communication traffic C_{i,j} becomes zero, and an attracting force f_{i,j} described later is not generated. To avoid such a situation that the attracting force f_{i,j} is not generated when the communication does not occur, the formula (1) defines the larger one of the result of the multiplication and the value “1” as the communication traffic C_{i,j} so that the attracting force is certainly generated.

C_{i,j}=MAX(20000×COMMUNICATION AMOUNT ×NUMBER OF COMMUNICATION, 1) (1)

The rank location change unit 302 then calculates the attracting force f_{i,j} acting between the rank i and the rank j by using the following formula (2) when the distance |rᵢ-rⱼ| between the rank i and the rank j is greater than a threshold value L₂ that is a predetermined reference value. According to the formula (2), as the amount of the communication traffic C_{i,j} increases, the attracting force f_{i,j} acting between the rank i and the rank j increases. As a result, the ranks between which the amount of the communication traffic C_{i,j} is large are placed near each other. According to the formula (2), as the distance between the rank i and the rank j increases, the attracting force f_{i,j} acting between the rank i and the rank j increases. That is to say, as the amount of the communication traffic C_{i,j} increases, and as the distance between the rank i and the rank j increases, the attracting force f_{i,j} with a larger magnitude is generated. For example, in molecular dynamics, by the effect of van der Waals force, the atoms strongly repel each other when the atoms come close to each other, while the atoms attract one another with small force when the atoms are distanced from each other. The present embodiment does not use van der Waals force itself, and applies the force different from van der Waals force between the rank i and the rank j.

$${f}_{i , j} = {C}_{i , j} \frac{\vec{{r}_{l}} - \vec{{r}_{l}}}{\vert {r}_{i} - {r}_{j} \vert} ( \vert {r}_{i} - {r}_{j} \vert - {L}_{2} ) ( {L}_{2} < \vert {r}_{i} - {r}_{j} \vert ) \qquad ( 2 )$$

On the other hand, the rank location change unit 302 calculates a repulsive force f_{i,j} acting between the rank i and the rank j by using the following formula (3) when the distance |rᵢ-rⱼ| between the rank i and the rank j is less than the threshold value L₂ and is greater than a predetermined threshold value L₁. According to the formula (3), as the distance between the rank i and the rank j decreases, the repulsive force with a larger magnitude is generated. The value “−−600” included in the formula (3) is a constant, and the constant may be changed as appropriate.

$${f}_{i , j} = - 600 \frac{\vec{{r}_{l}} - \vec{{r}_{J}}}{\vert {r}_{i} - {r}_{j} \vert} ( {L}_{2} - \vert {r}_{i} - {r}_{j} \vert ) ( {L}_{1} < \vert {r}_{i} - {r}_{j} \vert < {L}_{2} ) \qquad ( 3 )$$

On the other hand, the rank location change unit 302 calculates the repulsive force f_{i,j} acting between the rank i and the rank j by using the following formula (4) when the distance |rᵢ-rⱼ| between the rank i and the rank j is less than the threshold value L₁. According to the formula (4), as the distance between the rank i and the rank j further decreases, the repulsive force with a magnitude greater than that of the repulsive force obtained by the formula (3) is generated. The value “−50000” included in the formula (4) is a constant, and the constant may be changed as appropriate.

$${f}_{i , j} = - 50000 \frac{\vec{{r}_{l}} - \vec{{r}_{J}}}{\vert {r}_{i} - {r}_{j} \vert} ( {L}_{2} - \vert {r}_{i} - {r}_{j} \vert ) ( \vert {r}_{i} - {r}_{j} \vert < {L}_{1} ) \qquad ( 4 )$$

Thus, the relationship between the attracting force corresponding to the communication traffic between the ranks and the distance between the ranks and the repulsive force corresponding to the distance between the ranks is represented by the graph illustrated in FIG. 9A. As illustrated in FIG. 9A, when the distance between the rank i and the rank j is less than the threshold value L₁, a repulsive force is generated between the rank i and the rank j. When the distance between the rank i and the rank j is greater than the threshold value L₁, and is less than the threshold value L₂, a repulsive force weaker than the repulsive force generated when the distance between the rank i and the rank j is less than the threshold value L₁ is generated between the rank i and the rank j. When the distance between the rank i and the rank j is greater than the threshold value L₂, an attracting force is generated between the rank i and the rank j. Especially, the attracting force becomes stronger as the distance between the rank i and the rank j increases.

The rank location change unit 302 calculates a resultant force Fⱼ finally acting on the rank j by using the attracting force or the repulsive force calculated as described above and the following formula (5). According to the formula (5), as illustrated in FIG. 9B, the rank j receives the attracting force or the repulsive force corresponding to the distance from each of multiple ranks i. Therefore, the resultant force Fⱼ is obtained by combining the forces received from the multiple ranks i, and the moving direction of the rank j is thereby determined.

$${F}_{j} = {\sum }_{i ∈ all rank} {f}_{i , j} \qquad ( 5 )$$

The rank location change unit 302 then applies the calculated resultant force Fⱼ to each rank j, and changes the location of each rank j (step S103). As a result, the ranks, which concentrate on one point in each group in the initial state as illustrated in FIG. 7, generate strong repulsive forces because they are located very close to each other, and are scattered as illustrated in FIG. 10. When a time step described later has passed, the attracting force, the repulsive force, and the resultant force are calculated again based on the locations of the scattered ranks, and the locations of the ranks are changed again. The repetition of the above described process enables to obtain the convergence solution of the locations of the ranks.

When the rank location change unit 302 completes changing the locations of the ranks, the mapping information generating unit 303 then executes the alignment process on the changed locations of the ranks to generate the mapping information (step S104).

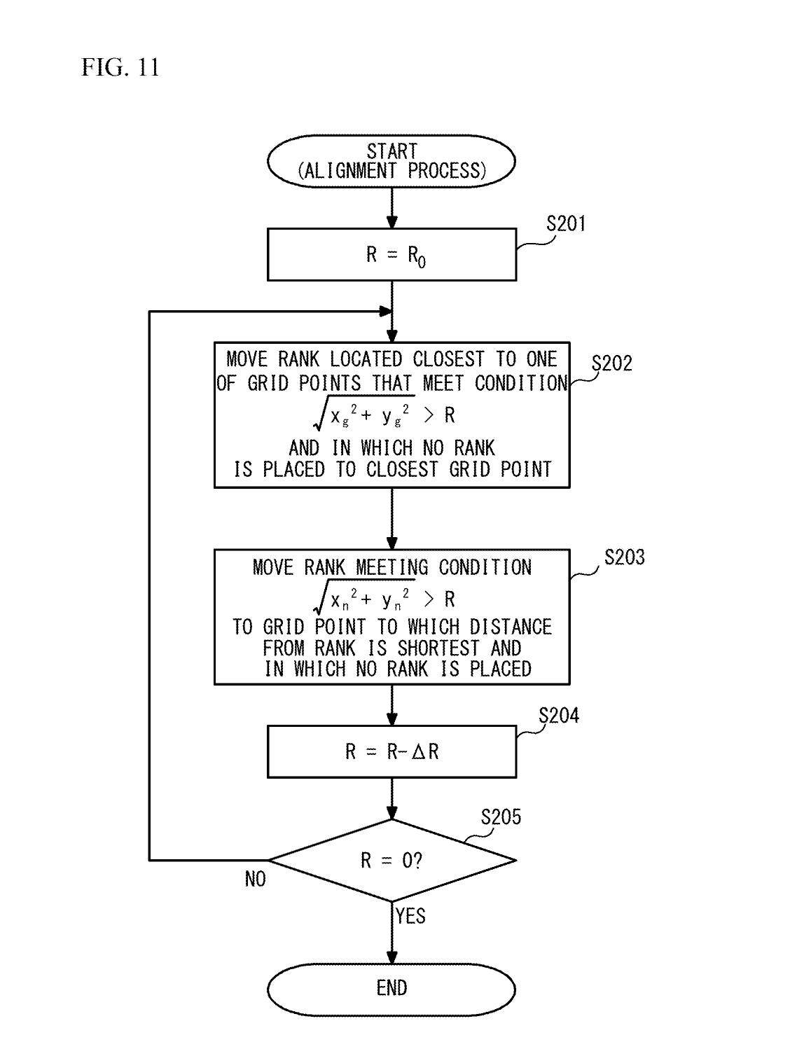

Here, with reference to FIG. 11 through FIG. 13B, a detailed description will be given of the alignment process executed on the changed locations of the ranks.

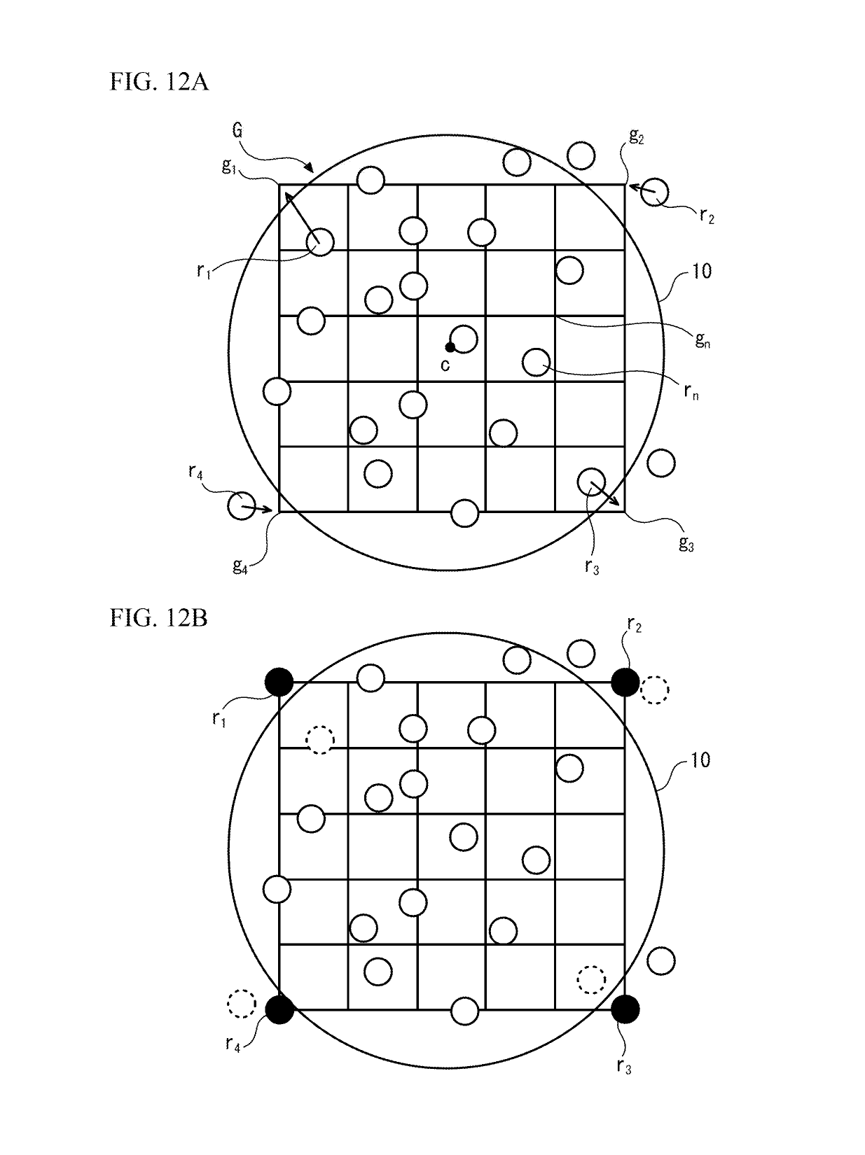

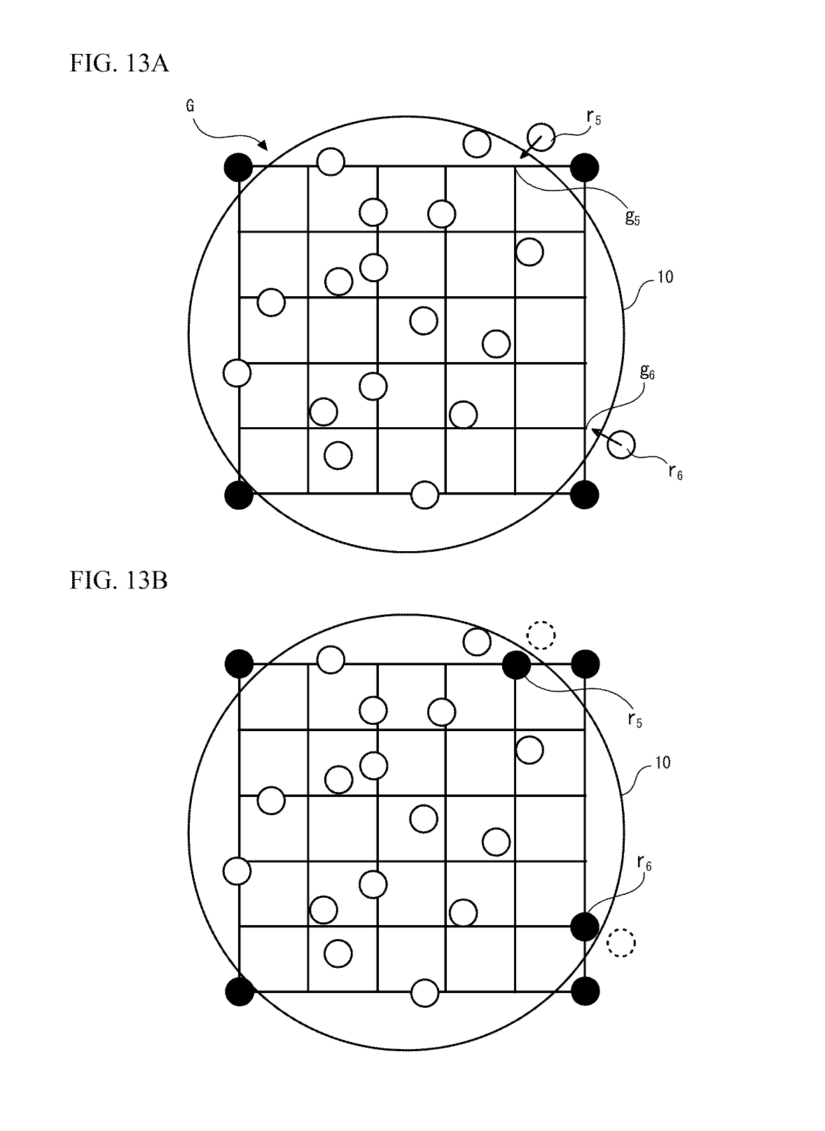

FIG. 11 is a flowchart of an example of the alignment process. FIG. 12 is a diagram for explaining the example of the alignment process. FIG. 13 is a diagram for explaining another example of the alignment process. A grid G in FIG. 12A and FIG. 13B represents one of the surfaces in a three-dimensional network topology, and grid points g₁, g₂, . . . , gₙ, . . . included in the grid G correspond to the multiple nodes 110. The mapping information generating unit 303 generates the mapping information by moving the ranks r₁, r₂, . . . , rₙ, . . . to the grid points g₁, g₂, . . . , gₙ, . . . to associate the ranks r₁, r₂, . . . , rₙ, . . . with the grid points g₁, g₂, . . . , gₙ, . . . .

The mapping information generating unit 303 sets an initial radius R₀ as a radius R of a circle 10 centered at a grid center c of the grid G illustrated in FIG. 12 (step S201). More specifically, the mapping information generating unit 303 sets the initial radius R₀ as the radius R to map the ranks r₁, r₂, . . . to the grid points g₁, g₂, g₃, g₄, . . . in order of being away from the grid center c of the grid G as illustrated in FIG. 12A. The initial radius R₀ may have a size including all grid points of the computing node group 100, for example. This process virtually-sets the circle 10 centered at the grid center c and having the radius R₀ as illustrated in FIG. 12A.

The mapping information generating unit 303 then moves a rank, which is located closest to one of grid points that are located outside the circle 10 with the radius R and in which no rank is placed (grid points at position (x_{g}, y_{g})), to the closest grid point of the above grid points (step S202). More specifically, as illustrated in FIG. 12A, the mapping information generating unit 303 specifies the grid points g₁, g₂, g₃, g₄ that are located outside the circle 10 with the radius R and in which no rank is placed. The mapping information generating unit 303 then specifies the rank r₁ located closest to the grid point g₁, the rank r₂ located closest to the grid point g₂, the rank r₃ located closest to the grid point g₃, and the rank r₄ located closest to the grid point g₄. Finally, as illustrated in FIG. 12B, the mapping information generating unit 303 moves the rank r₁ to the grid point g₁, the rank r₂ to the grid point g₂, the rank r₃ to the grid point g₃, and the rank r₄ to the grid point g₄.

The mapping information generating unit 303 then moves a rank located outside the circle 10 with the radius R to a grid point (a grid point at position (xₙ, yₙ)) to which the distance from the rank is shortest and in which no rank is placed (step S203). More specifically, as illustrated in FIG. 13A, the mapping information generating unit 303 specifies ranks r₅, r₆ located outside the circle 10 with the radius R. The mapping information generating unit 303 then specifies the grid point g₅ to which the distance from the rank r₅ is shortest and in which no rank is placed, and the grid point g₆ to which the distance from the rank r₆ is shortest and in which no rank is placed. Finally, as illustrated in FIG. 13B, the mapping information generating unit 303 moves the rank r₅ to the grid point g₅, and the rank r₆ to the grid point g₆. When grid points to which the distance from two or more ranks located outside the circle 10 with the radius R is shortest and in which no ranks is placed are the same grid point, the mapping information generating unit 303 selects one of the ranks, and moves the selected rank to the grid point of which the distance from the selected rank is shortest and in which no rank is placed. After moving the selected rank, the mapping information generating unit 303 selects another rank from the remaining ranks, and moves the selected another rank to the grid point of which the distance from the selected another rank is secondly shortest and in which no rank is placed. The mapping information generating unit 303 repeats the same process after moving the selected another rank.

When the process of step S203 is completed, the mapping information generating unit 303 sets a new radius R smaller than the present radius R by ΔR (step S204), and determines whether the new radius R is zero (step S205). When the mapping information generating unit 303 determines that the new radius R is not zero (step S205: NO), the aforementioned processes of steps S202 and S203 are repeated. This allows the mapping information generating unit 303 to map ranks to the grid points in order of being away from the grid center c in a concentric fashion. When the mapping information generating unit 303 determines that the new radius R is zero (step S205: YES), the mapping information generating unit 303 ends the alignment process. The mapping information generating unit 303 transmits the locations of the ranks after the alignment process to the mapping information evaluation unit 304 as the mapping information.

Back to FIG. 8, a description will be given of the process after step S105.

When the process of step S104 is completed, the mapping information evaluation unit 304 calculates the evaluation value E of the mapping information with a predetermined evaluation formula (step S105). The predetermined evaluation formula is represented by the following formula (6).

$$E = {\sum }_{i , j ∈ all rank} ( {hop}_{i , j} \times {size}_{i , j} ) \qquad ( 6 )$$

Here, hop_{i,j} in the formula (6) represents the number of communication hops between the rank i and the rank j. Size_{i,j} in the formula (6) represents the communication amount between the rank i and the rank j. That is to say, the evaluation value E in the formula (6) represents the sum of the values calculated by multiplying the number of communication hops and the communication amount of all the combination of the rank i and the rank j. According to the formula (6), when the ranks between which the large amount of communication is performed are located so that the number of communication hops between them is small, the evaluation value E is small.

After calculating the evaluation value E, the mapping information evaluation unit 304 determines whether the evaluation value E is improved (step S106). More specifically, when the evaluation value E′ that has been already calculated is stored in the mapping information storing unit 305, the mapping information evaluation unit 304 reads the evaluation value E′ from the mapping information storing unit 305. The mapping information evaluation unit 304 then compares the evaluation value E′ that has been read out with the evaluation value E most recently calculated. When the mapping information evaluation unit 304 determines that the evaluation value E′ is greater than the evaluation value E, it determines that the evaluation value E is improved (step S106: YES), and outputs the mapping information to the mapping information storing unit 305 (step S107). At that time, the mapping information evaluation unit 304 may output the evaluation value E to the mapping information storing unit 305 together with the mapping information.

When the process of step S107 is completed, the mapping information evaluation unit 304 determines whether the evaluation value E is less than an evaluation threshold value (step S108). The evaluation threshold value is a threshold value used to determine whether the mapping information is sufficiently optimized. When the mapping information evaluation unit 304 determines that the evaluation value E is less than the evaluation threshold value (step S108: YES), it ends the process.

On the other hand, when the mapping information evaluation unit 304 determines that the evaluation value E is not improved at step S106 (step S106: NO), or determines that the evaluation value E is not less than the evaluation threshold value (step S108: NO), it determines whether a time step ts has reached the upper limit T (step S109). Here, the time step ts represents the number of times that the mapping information is generated. The upper limit T may be determined in advance.

When the mapping information evaluation unit 304 determines that the time step ts has reached the upper limit T (step S109: YES), it ends the process. On the other hand, when the mapping information evaluation unit 304 determines that the time step ts has not reached the upper limit T (step S109: NO), it repeats the processes from step S102 to step S108. Thus, the mapping information evaluation unit 304 generates and evaluates the mapping information repeatedly till the time step ts reaches the upper limit T (e.g., 4000 time steps). In the process, when the mapping information evaluation unit 304 calculates the evaluation value E less than the evaluation threshold value, it stores the mapping information that has been used to calculate the evaluation value E in the mapping information storing unit 305. In contrast, when the mapping information evaluation unit 304 calculates the evaluation value E greater than or equal to the evaluation threshold value, it causes the time step ts to increase, and the mapping information generating unit 303 generates new mapping information. Then, the mapping information evaluation unit 304 evaluates the new mapping information.

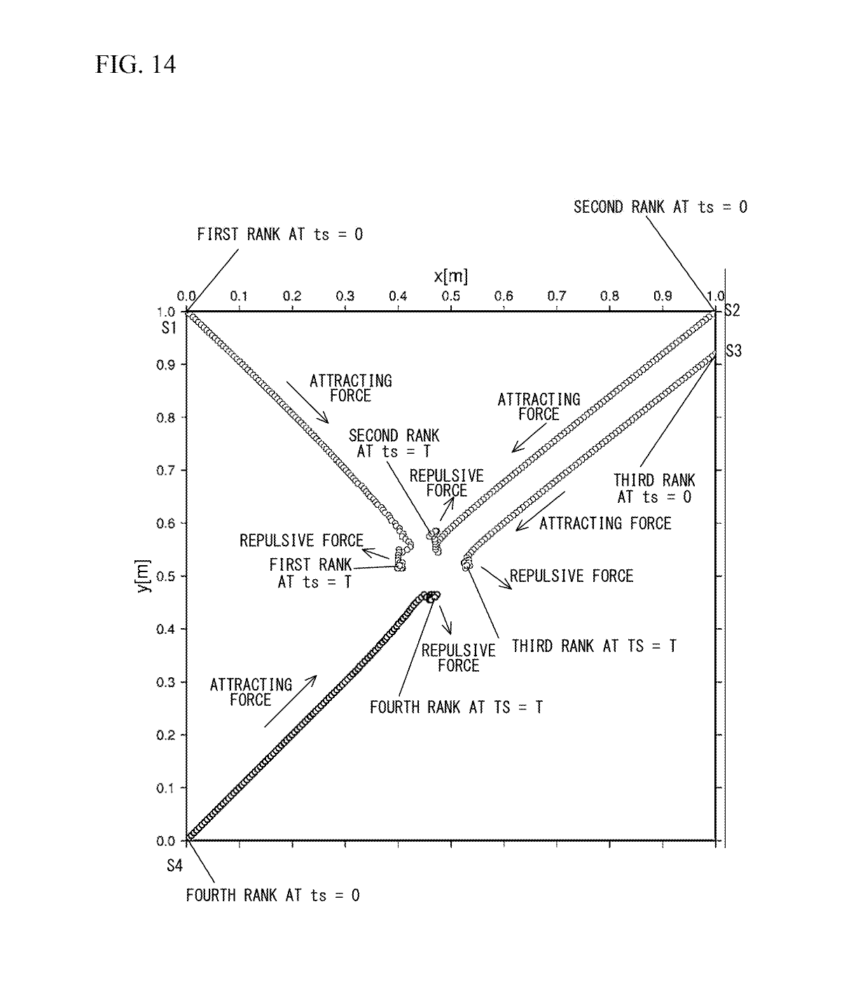

With reference to FIG. 14, a description will be given of how the locations of the ranks converge.

FIG. 14 is a diagram for explaining examples of trajectories of ranks of which the locations in the XY plane change as the time step ts increases. The same applies to the XZ plane and the YZ plane. As illustrated in FIG. 14, at time step ts=0, a first rank, a second rank, a third rank, and a fourth rank are located at four starting points S1, S2, S3, and S4, respectively. Here, since the distance between each two of the first rank, the second rank, the third rank, and the fourth rank is greater than the threshold value L₂, attracting forces are generated. As the time step ts increases, the first rank, the second rank, the third rank, and the fourth rank move so as to come closer to each other. Furthermore, each of the first rank, the second rank, the third rank, and the fourth rank generates a repulsive force when the distance between them becomes less than the threshold value L₂. Therefore, the first rank, the second rank, the third rank, and the fourth rank repel each other near the center of the XY plane, and move so as to back away from each other. When the time step ts has reached the upper limit T, the first rank, the second rank, the third rank, and the fourth rank stop moving. Thus, the locations of the first rank, the second rank, the third rank, and the fourth rank when the time step ts is the upper limit T correspond to the final locations of the ranks before the alignment process. These locations of the ranks are convergence solutions. In FIG. 14, when the upper limit T of the time step ts is set to a value before the repulsive forces are generated, the ranks move based on only the attracting forces, and the locations of the ranks converge. In the same manner, in FIG. 7, when the upper limit T of the time step ts is set to a value before the attracting forces are generated, the ranks move based on only the repulsive forces, and the locations of the ranks converge.

Here, a relationship between the coordinates of each rank before move and the coordinates after the move are represented by the following formulas (7) through (12). In the formulas (7) through (9), k is a constant that represents a travel distance preliminarily set. Thus, the travel distances of the first rank, the second rank, the third rank, and the fourth rank in FIG. 14 are constant. F_{x,j}, F_{y,j}, F_{z,j} presented in a numerator in the formulas (10) through (12) are an x component, a y component, and a z component of the resultant force Fⱼ described above, respectively, and a denominator represents the magnitude (length) of the resultant force Fⱼ.

xₙⁿ⁺¹=xₙⁿ+kΔxⱼ (7)

yⱼⁿ⁺¹=yⱼⁿ+kΔyⱼ (8)

zⱼⁿ⁺¹=zⱼⁿ+kΔzⱼ (9)

Δxⱼ=F_{x,j}/|\vec{F}| (10)

Δyⱼ=F_{y,j}/|\vec{F}| (11)

Δzⱼ=F_{z,j}/|\vec{F}| (12)

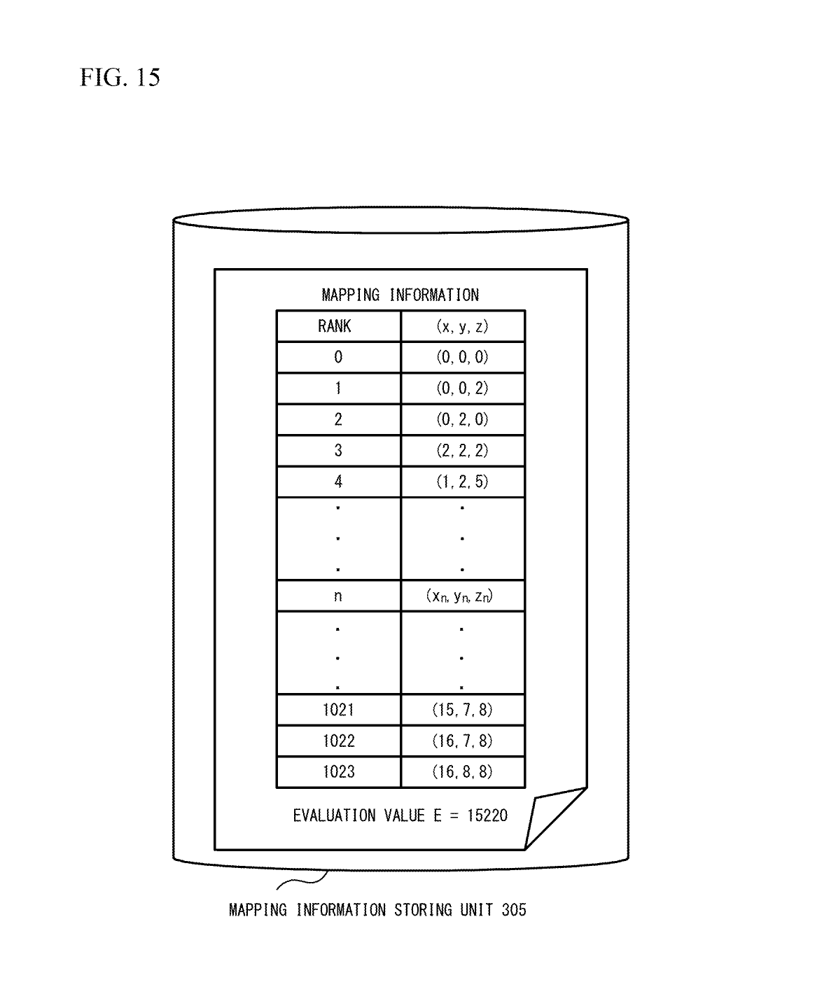

A description will be given of the mapping information with reference to FIG. 15.

FIG. 15 illustrates an exemplary mapping information. The mapping information is stored in the mapping information storing unit 305 as described above. The evaluation value E may be stored in the mapping information storing unit 305 together with the mapping information. The mapping information is represented by the relationship between the rank and the coordinates of the node 110. For example, the rank “n” (in more detail, the process given the rank “n”) is assigned to the node 110 placed in the coordinates (xₙ, yₙ, zₙ). Here, n is an integer from 0 to 1023.

As described above, the mapping information generating apparatus 300 in accordance with the present embodiment places multiple ranks in a space constructed on a computer, and changes the positions of the multiple ranks by applying at least one of an attracting force and a repulsive force between each two ranks included in the multiple ranks in the space. The mapping information generating apparatus 300 then generates mapping information that maps the multiple ranks to the multiple nodes 110 based on the changed positions of the multiple ranks and obtained positions of the multiple nodes 110. When the Simulated Annealing is employed in such a large scale parallel computing system S, the large quantity of calculation is required to generate the mapping information. However, the use of the mapping information generating apparatus 300 in accordance with the present embodiment can reduce the computing amount required to generate the mapping information even in the large scale parallel computing system S.

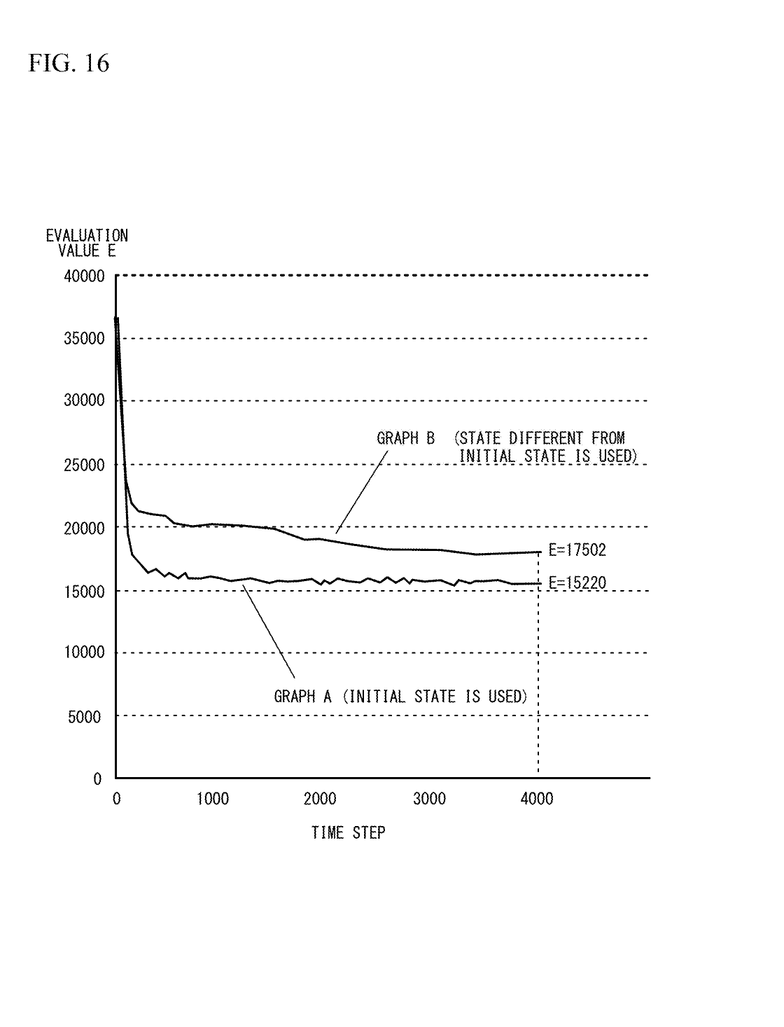

A description will be given of the difference in the evaluation value E between when the initial state is present and when the initial state is absent with reference to FIG. 16.

FIG. 16 is a graph illustrating a relationship between the increase of the time step ts and the evaluation value E. In FIG. 16, a graph A illustrates a case where the initial state is used, and a graph B illustrates a case where a state different from the initial state is used. Here, the state different from the initial state is a state where the order of the ranks corresponds to the order of the coordinates of the nodes 110. The state is, for example, a state where the rank “0” (in more detail, a process given the rank “0”. The same applies hereafter.) is assigned to the node 110 of coordinates (0, 0, 0), and the rank “1” is assigned to the node 110 of coordinates (1, 0, 0), . . . , the rank “1023” is assigned to the node 110 of coordinates (16, 8, 8).

As illustrated in FIG. 16, as the time step ts increases from time step ts=0, the evaluation value E sharply decreases at the beginning in both the graph A and the graph B. Then, the declination is reduced in both the graph A and the graph B, and the evaluation value E converges on a constant evaluation value E. Here, when the initial state is used, the evaluation value E converges on E=15220 at 4000 time steps that is the upper limit T of the time step ts. On the other hand, when the state different from the initial state is used, the evaluation value E converges on E=17502 at 4000 time steps that is the upper limit T of the time step ts.

As described above, the evaluation value E calculated with use of the initial state becomes less than the evaluation value E calculated with use of the state different from the initial state. Thus, the use of the initial state enables to obtain mapping information more appropriate than the mapping information generates with use of the state different from the initial state. The evaluation value E calculated based on the state different from the initial state without using the mapping information generating apparatus 300 of the present embodiment converges on E=31608. Thus, even when the initial state is not used, if the state different from the initial state is used and the mapping information generating apparatus 300 of the present embodiment is used, the mapping information can be generated with a small computing amount even in the large scale parallel computing system S.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, a history of how the ranks move illustrated in FIG. 14 may be displayed on the terminal device 400 of the user. This allows the use to see how the locations of the ranks change as the time passes.

What is claimed is:

1. A non-transitory computer readable medium storing a mapping information generation program that causes a computer to execute a process, the process comprising:
placing a plurality of processes in a space generated by a computer;
changing positions of the plurality of processes by applying at least one of an attracting force and a repulsive force between each two processes included in the plurality of processes; and
generating information that maps the plurality of processes to a plurality of processors based on changed positions of the plurality of processes and positions of the plurality of processors.

2. The non-transitory computer readable medium according to claim 1, wherein
the changing includes changing the positions of the plurality of processes by applying an attracting force corresponding to communication traffic between the each two processes between the each two processes.

3. The non-transitory computer readable medium according to claim 1, wherein
the changing includes changing the positions of the plurality of processes by further applying a repulsive force corresponding to a distance between processes included in the plurality of processes between the processes when the distance between the processes is greater than a reference value.

4. The non-transitory computer readable medium according to claim 2, wherein
the changing includes calculating the communication traffic based on information on a communication amount and a number of communication between the each two processes.

5. The non-transitory computer readable medium according to claim 1, wherein
the changing includes changing the positions of the processes by further applying a repulsive force corresponding to a distance between processes between the processes when the distance between the processes is less than a reference value.

6. The non-transitory computer readable medium according to claim 1, wherein
the process further comprises, before the changing:
dividing the plurality of processes into a plurality of groups based on communication frequency between the each two processes; and
placing processes included in each group in an area corresponding to the group.

7. The non-transitory computer readable medium according to claim 1, wherein
the generating includes determining a processor to which each process is assigned among the plurality of processors based on a distance between the each process included in the plurality of processes of which the positions are changed and each processor included in the plurality of processors.

8. A mapping information generating method implemented by a computer, the mapping information generating method comprising:
placing a plurality of processes in a space generated by a computer;
changing positions of the plurality of processes by applying at least one of an attracting force and a repulsive force between each two processes included in the plurality of processes; and
generating information that maps the plurality of processes to a plurality of processors based on changed positions of the plurality of processes and positions of the plurality of processors.

9. A mapping information generating apparatus comprising:
a processor that executes a process including:
placing a plurality of processes in a space generated by a computer;
changing positions of the plurality of processes by applying at least one of an attracting force and a repulsive force between each two processes included in the plurality of processes in the space; and
generating information that maps the plurality of processes to a plurality of processors based on changed positions of the plurality of processes and positions of the plurality of processors.

10. The mapping information generating apparatus according to claim 9, wherein
the changing includes changing the positions of the plurality of processes by applying an attracting force corresponding to communication traffic between the each two processes between the each two processes.

11. The mapping information generating apparatus according to claim 9, wherein
the changing includes changing the positions of the plurality of processes by further applying a repulsive force corresponding to a distance between processes included in the plurality of processes between the processes when the distance between the processes is greater than a reference value.

12. The mapping information generating apparatus according to claim 10, wherein
the changing includes calculating the communication traffic based on information on a communication amount and a number of communication between the each two processes.

13. The mapping information generating apparatus according to claim 9, wherein
the changing includes changing the positions of the processes by further applying a repulsive force corresponding to a distance between processes between the processes when the distance between the processes is less than a reference value.

14. The mapping information generating apparatus according to claim 9, wherein
the process further includes, before the changing:
dividing the plurality of processes into a plurality of groups based on communication frequency between the each two processes; and
placing processes included in each group in an area corresponding to the group.

15. The mapping information generating apparatus according to claim 9, wherein
the generating includes determining a processor to which each process is assigned among the plurality of processors based on a distance between the each process included in the plurality of processes of which the positions are changed and each processor included in the plurality of processors.

16. A mapping information generating method implemented by a computer, the mapping information generating method comprising:
placing a plurality of processes in a space generated by a computer;
changing positions of the plurality of processes by applying at least one of an attracting force and a repulsive force between each two processes included in the plurality of processes;
generating information that maps the plurality of processes to a plurality of processors based on changed positions of the plurality of processes and positions of the plurality of processors; and
displaying a history of how the positions of the plurality of processes are changed.
